(19) United States
(12) Patent Application Publication
(10) Pub. No.: US 2022/0383781 A1
(43) Pub. Date: Dec. 1, 2022

(54) AIRBORNE ELECTRONIC SIGN SYSTEM

(71) Applicant: Gary O Sandstedt, St. Louis, MO (US)

(72) Inventor: Gary O Sandstedt, St. Louis, MO (US)

(21) Appl. No.: 17/332,176

(22) Filed: May 27, 2021

(51) Int. Cl. G09F 21/12; B64D 47/02; G09F 9/30; G09F 27/00; B64C 39/02; G08G 1/0955

(52) U.S. Cl. CPC G09F 21/12; B64D 47/02; G09F 9/30; G09F 27/00; B64C 39/024; G08G 1/0955; B64C 2201/122

(57) ABSTRACT

A multi-imaging mobile, airborne sign system, printed or electronic, hosted aloft by multiple means of aircraft, including those lighter than air.

Printed airborne signs displayed on blimps, and those towed behind small, fixed wing, aircraft have been in existence for decades, but with the advent of LED technology, electronic signs have changed the dynamics of advertising, to include the possibility of message scrolling script, video presentations, animation, and after dark viewing, all of which can be programmed, and displayed, using various forms of electronic technology, and communication.

In recent years, signs of virtually every configuration, using LED technology have become ubiquitous throughout the industrialize world.

However, most have had limited exposure since their location, in relation to a potential viewer, is restricted.

The solution to these problems is to take electronic signs airborne, using any conveyance that can self-sustain its air worthiness, such as airliners, drones, helicopters, and lighter than air, craft, which includes balloons, blimps, and dirigibles.

The displaying of an electronic sign from an altitude increases the viewing exposure, exponentially.

For example, a ground level sign shows that, in order for it to be properly seen, it must be viewed in close proximity.

But the same sign when suspended at an altitude, over a sporting event, concert, or the general population, can be viewed simultaneously by countless thousands of people, thereby providing a means of low cost advertising, to the masses, not obtainable through other venues.

Furthermore, for daytime public viewing, multiple printed signs can be sequentially displayed, at an elevation, to compliment nighttime electronic sign viewing.

### OBJECTS OF THIS INVENTION

#1. To provide a low cost means of advertising to a captive mass audience.

#2. To provide a simple, and versatile means of mass market advertising across all boundaries.

#3. To provide an economical means of selective mass market advertising.

#4. To provide a venue for small businesses to economically mass market.

#5. To provide a means of circumventing other forms of expensive mass market advertising.

#6. To take advertising to the public, rather than the public having to find a stationary signs at a fixed location.

### PRIOR ART

No other technology provides the facilities of this invention, as it pertains to airborne signs, both printed and electronic.

### BRIEF DESCRIPTION OF THE DRAWINGS

FIG. 1, shows an exposed top view of an airborne conveyance, in the form of an airliner, hosting an electronic sign, for inside cabin passenger viewing.

FIG. 2, shows an airborne conveyance, at an elevation, hosting an external sign.

FIG. 3, shows a hovering airborne conveyance, at an elevated position, hosting either a printed, or electronic sign.

FIG. 4, shows a hand carried storage means of transferring display data from a programmer to an electronic sign, for public viewing.

FIG. 5, shows a lighter than air, craft, holding an elevated sign.

### DETAILED DESCRIPTION OF AN EMBODIMENT

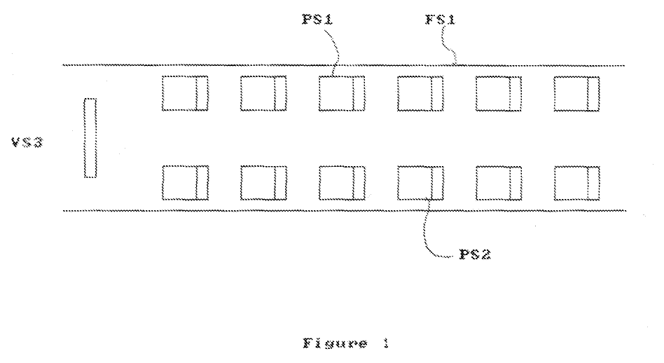

FIG. 1, shows FS1, an open top view of the passenger section of an airliner, with multiple rows of seats, PS1, and PS2, in addition to positioned viewing sign VS2.

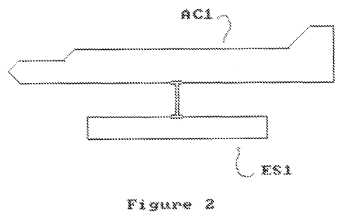

FIG. 2, shows airborne conveyance AC1, hosting sign ES1.

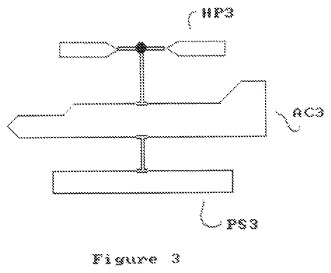

FIG. 3, shows airborne conveyance AC3, hosting sign PS3, while hovering, at an elevation, through means of powered rotor blades HP3,

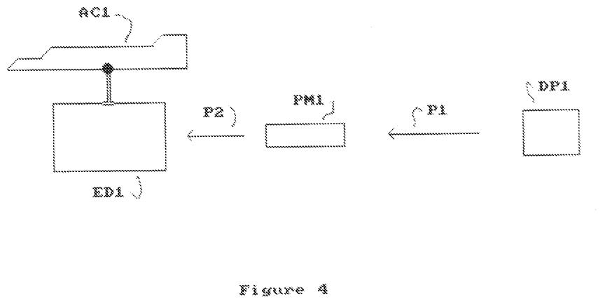

FIG. 4, shows hand carried portable storage means PM1, physically moving along path P1, holding display data previously off-loaded from programmer DP1, and further moving along path P2, where its destined data is off-loaded as images for public viewing on electronic sign ED1, hosted by airborne conveyance AC1,

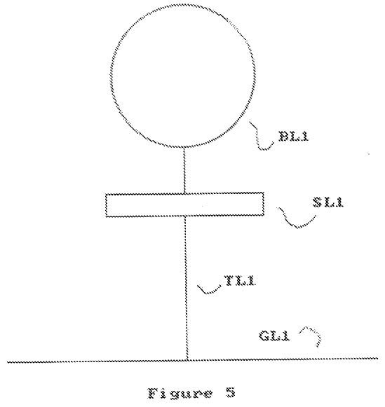

FIG. 5, shows sign SL1, held aloft by balloon BL1, anchored to ground level GL1, by teather TL1.

What is claimed:

1. A mobile electronic sign system, with means to display images of multicolored script, graphics, video presentations, and animation, for public viewing, singularly or, in any combination, thereof, internal, and/or external, from at least one airborne hosting conveyance, including an airplane, drone, helicopter, and those lighter than air.

2. A mobile sign system, with means to display images, sequentially, for viewing, from aloft, when hosted by an airborne conveyance.

3. The invention of claims 1, and 2, whose mobile sign, hosted from an airborne conveyance, has means to change its displayed image, based on a geographic location.

4. The invention of claim 1, whose display memory is downloaded with data from a media generating source using:
A. At least, one wireless radio frequency means, through the facilities of at least one communicating satellite, in real time.
B: At least, one wireless radio frequency means, through the facilities of at least one communicating terrestrial source, in real time.
C: At least, one cell phone communications means, to include digital, and/or analog technology, in real time.
D. At least, one hard-wired communication means to include digital, and/or analog technology, in real time.

5. The invention of claims 1, and 2, comprising:
A. At least, one hand carried portable memory device, with data pre-loaded, digitally, from an electronic sign programming source, to be later transferred too, and displayed through an airborne electronic sign system, as images, for public viewing.
B. At least, one hand carried portable memory device, with data pre-loaded as audio tones, from an electronic sign programming source, to be later transferred too, and displayed through an airborne electronic sign system, as images, for public viewing.

6. The invention of claims 1, and 2, whose airborne sign conveyance is piloted by at least:
A: One occupant.
B: One data processor.

7. The invention of claims 1, and 2, whose airborne sign conveyance is configured to accommodate, at least:
A. One single sided electronic sign.
B. One double sided electronic sign.
C. One single sided printed sign.
D. One double sided printed sign.
E. One sign on which one side is printed, and the opposite side is electronic.

8. The invention of claims 1, and 2, whose sign conveyance, by means of an onboard data processor, is programmed to automatically take flight, follow a prescribed airborne pattern, and land, all autonomously.

9. The invention of claims 1, and 2, comprising means of satellite communications to deliver an onboard payload at a specific geographic location.

10. The invention of claims 1, and 2, comprising means to:
A: Simulate the setting off of fireworks, aloft, by means of at least one electronic sign display.
B: Simulate the setting off of fireworks, aloft, by means of at least one electronic sign display, in association with chemical based fireworks.

11. The invention of claims 1, and 2, comprising means to display airborne geometric patterns.

12. The invention of claims 1, and 2, comprising means to work in tandem with other like devices.

13. The invention of claim 1, comprising means to direct traffic through airborne information displays.

14. The invention of claims 1, and 2, comprising means to produce sounds from an airborne elevation.

15. The invention of claims 1, and 2, comprising:
A: Solar powered means.
B: Battery powered means.
C: Hydrocarbon powered means.

16. The invention of claims 1, and 2, comprising means of a conveyance hosted sign to return to a home base automatically, using satellite technology.

17. The invention of claims 1, and 2, comprising means to travel a geographic pattern under control of, at least, one global positioning satellite.

18. The invention of claim 2, comprising means to hold a library of information, contained on monochrome, or colored printed signs, individually sequenced, in an order, from a common holding queue, into public view, under control of a data processor, while hosted by an airborne conveyance.

19. The invention of claims 1, and 2, comprising a lighter than air host conveyance, tethered to an anchor.
